(19) United States
(12) Patent Application Publication
(10) Pub. No.: US 2024/0378536 A1
(43) Pub. Date: Nov. 14, 2024

(54) TASK-RELATED DATA PROCESSING USING MACHINE LEARNING TECHNIQUES

(71) Applicant: Dell Products L.P., Round Rock, TX (US)

(72) Inventors: Abhishek Mishra, Bangalore (IN); Vivek Bhargava, Bangalore (IN); Vaideeswaran Ganesan, Bangalore (IN); Rishav Sethia, Bengaluru (IN)

(21) Appl. No.: 18/196,549

(22) Filed: May 12, 2023

(51) Int. Cl. H04L 41/16; H04L 41/5003

(52) U.S. Cl. CPC G06Q 10/0637; G06Q 10/063112

(57) ABSTRACT

Methods, apparatus, and processor-readable storage media for task-related data processing using machine learning techniques are provided herein. An example computer-implemented method includes obtaining data related to at least one decision-making context in connection with at least one user; classifying at least a portion of the obtained data into one or more of multiple categories of action-related requirements associated with the at least one decision-making context; recommending one or more tasks in furtherance of the at least one decision-making context by processing at least a portion of the classified data using one or more machine learning techniques; and performing one or more automated actions based at least in part on the one or more recommended tasks.

### FIELD

The field relates generally to information processing systems, and more particularly to task management in such systems.

### BACKGROUND

Complex decision-making often presents challenges to uses and systems. For example, it may be difficult to assess options with respect to a variety of usage needs, legal requirements, technological nuances, follow-on effects, temporal ramifications, etc. However, conventional decision-making approaches commonly rely on limited information and/or static rules, often leading to error-prone and resource-intensive outcomes.

### SUMMARY

Illustrative embodiments of the disclosure provide techniques for task-related data processing using machine learning techniques.

An exemplary computer-implemented method includes obtaining data related to at least one decision-making context in connection with at least one user, and classifying at least a portion of the obtained data into one or more of multiple categories of action-related requirements associated with the at least one decision-making context. The method also includes recommending one or more tasks in furtherance of the at least one decision-making context by processing at least a portion of the classified data using one or more machine learning techniques. Further, the method additionally includes performing one or more automated actions based at least in part on the one or more recommended tasks.

Illustrative embodiments can provide significant advantages relative to conventional decision-making approaches. For example, problems associated with error-prone and resource-intensive outcomes are overcome in one or more embodiments through automatically processing data related to at least one decision-making context using machine learning techniques and recommending one or more tasks in furtherance of the at least one decision-making context.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for task-related data processing using machine learning techniques in an illustrative embodiment.

FIG. 2 shows an example insurance-related decision tree in an illustrative embodiment.

FIG. 3 shows an example deployment-related decision tree in an illustrative embodiment.

FIG. 4 shows an example deployment-related decision tree in an illustrative embodiment.

FIG. 5 is a flow diagram of a process for task-related data processing using machine learning techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

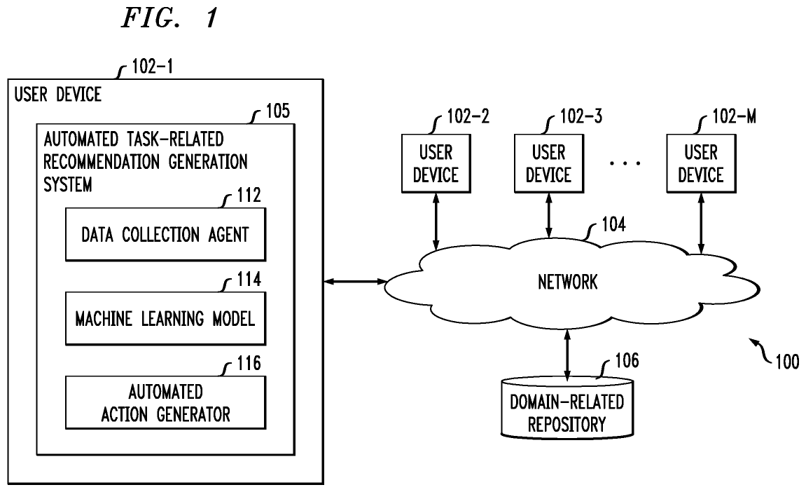

FIG. 1 shows a computer network (also referred to herein as an information processing system) 100 configured in accordance with an illustrative embodiment. The computer network 100 comprises a plurality of user devices 102-1, 102-2, 102-3, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment.

As further detailed herein, user devices include automated task-related recommendation generation system 105. Further, the user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, one or more of the user devices 102 can have an associated domain-related repository 106 configured to store data pertaining to various decision-making contexts and tasks related thereto, which comprise, for example, functional requirements, non-functional requirements, user-related patterns, etc.

The domain-related repository 106 in the present embodiment is implemented using one or more storage systems associated with user devices 102. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with one or more of the user devices 102 are one or more input-output devices, which illustratively comprise keyboards, displays or other types of input-output devices in any combination. Such input-output devices can be used, for example, to support one or more user interfaces to user devices 102, as well as to support communication between user devices 102 and other related systems and devices not explicitly shown.

Each user device 102 in the FIG. 1 embodiment is assumed to be implemented using at least one processing device. Each such processing device generally comprises at least one processor and an associated memory, and implements one or more functional modules for controlling certain features of the user device 102.

More particularly, user devices 102 in this embodiment each can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the user devices 102 to communicate over the network 104 with the user devices 102, and illustratively comprises one or more conventional transceivers.

The automated task-related recommendation generation system 105 further comprises data collection agent 112, machine learning model 114, and automated action generator 116.

It is to be appreciated that this particular arrangement of elements 112, 114 and 116 illustrated in the automated task-related recommendation generation system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for task-related data processing using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated task-related recommendation generation system 105 and domain-related repository 106 can be on and/or part of the same processing platform.

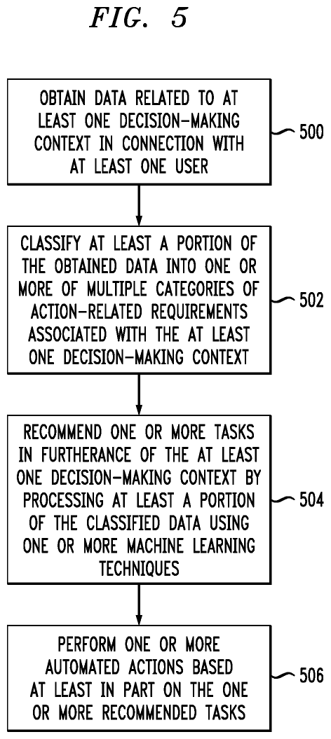

An exemplary process utilizing elements 112, 114 and 116 of an example user device 102 in computer network 100 will be described in more detail with reference to the flow diagram of FIG. 5.

Accordingly, at least one embodiment includes task-related data processing using machine learning techniques. Such an embodiment can include implementation in a context such as, e.g., a decision-making or other task-related scenario wherein a user and/or related system possesses limited knowledge pertaining to the decision(s) (and, for example, may possess questions related to the type of effort involved, the sorts of approvals needed, the amount of time needed to accomplish each of one or more tasks, ramifications of various decision options, etc.). Accordingly, such an embodiment includes automatically generating information and/or answers to address at least a portion of such limited knowledge, and performing one or more automated actions based on such information generation (e.g., outputting at least a portion of such generated information to at least one user and/or system, automatically initiating a decision determination and/or related action, etc.).

By way of example, in at least one embodiment, based at least in part on such generated information, at least one user can make an informed decision pertaining to at least one solution and/or outcome to a decision-making context with increased confidence and without needing to learn and/or understand specialized terminology and/or jargon related to the decision-making context.

In one or more embodiments, a data collection agent is implemented to learn and/or understand a user's needs with respect to a decision-making context, and providing one or more solution options (e.g., the most optimized solution) based at least in part thereon. In such an embodiment, the data collection agent collects various decision-making context-related data (e.g., metrics, historical data, usage parameters, etc.), ensures confidentiality of the data as necessary, and abstracts one or more items of information from the collected data to be used to determine at least one decision-making solution.

As further detailed herein, one or more embodiments include building one or more domain repositories, building one or more domain expertise query repositories, and performing intent-based reprovisioning.

With respect to building one or more domain repositories, given any specific domain (e.g., insurance, technology deployments, etc.), domain experts (e.g., insurance agents, information technology administrators, etc.) commonly ask a specific set of questions in a specific order in furtherance of reaching a solution and/or outcome to a particular decision-making context. Such actions can result, for example, in narrowing solution options, increasing the identifications of elements needed to reach a solution, providing additional and/or increased clarity on the intent(s) of one or more entities involved in the decision-making context, and attempting to predict one or more future needs of one or more entities involved in the decision-making context based at least in part on one or more current parameters.

Additionally, one or more embodiments include comparing one or more items of vagueness with respect to building one or more domain repositories. By way of example, users often have privacy concerns sharing information with subject matter experts, and users may not be aware of the subject matter expert's perspective and often give vague answers. As a result, subject matter experts will need to estimate the needs of users, often with insufficient data and/or assumptions. Accordingly, in at least one embodiment, the one or more domain repositories can be built to contain the following information, given a particular domain. For example, such information can include one or more parameters that define the scope and direction of discussion with respect to the corresponding decision-making context. Such information can also include functional requirements that can help provide context for the one or more parameters, which can be used to predict future needs, parameters for the solution, etc. Additionally, such information can include non-functional requirements that provide additional context for a domain expert to project one or more solutions, and user intent and/or priority detection parameters, which help collect data that discover user intent and help provide insights to domain experts.

The domain repositories can contain such parametric information derived from different vendors and/or data sources. Such a repository can be created by analyzing user-related data such as application forms, proposal request forms, etc., wherein the order, sequence and grouping of such data are collected from each of such forms. In one or more embodiments, the repositories are enriched by collecting metadata from different entities (for example, various insurance entities or deployment teams within an organization).

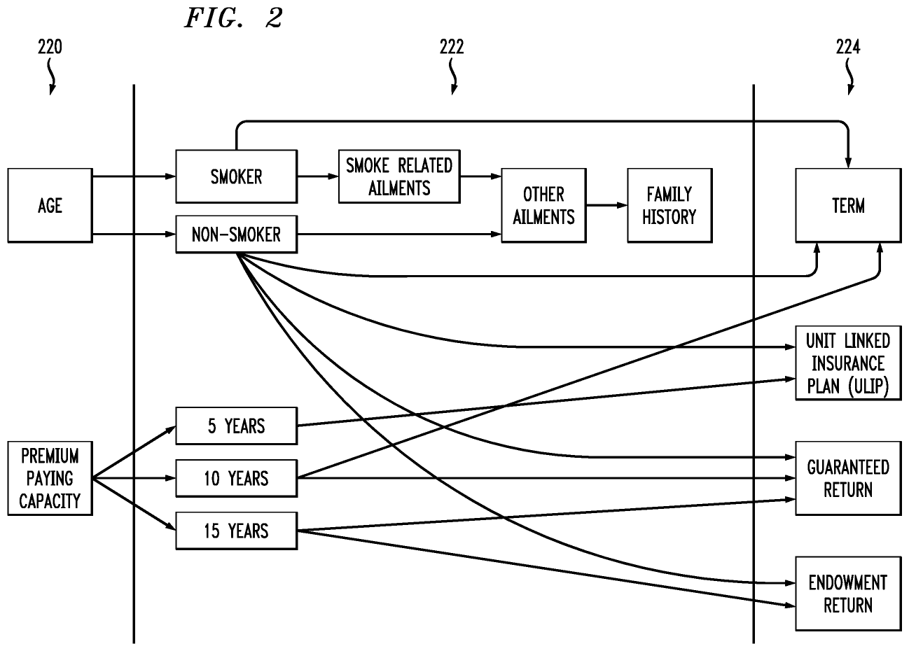

With respect to building one or more domain expertise query repositories, at least one embodiment includes facilitating at least one mechanism (e.g., a data collection agent) to be able to interpret metadata stored in the one or more domain repositories. Such a repository can be built as follows. For one or more user parameters, a state machine model is built from functional requirement information. The functional requirements can be ordered, for example, in priority and in the form of a network diagram. For example, in an insurance context, information may be sought along the lines of the current age of a person, whether the person is married or not (based on age), whether the person is a smoker and/or have any ailments related to age, and other medical history and/or family medical history. Such progressive questions can provide a perspective on the level of health risk associated with the given user. Creating a diagram of this, such as depicted, for example, in FIG. 2, can help in connection with one or more embodiments reflecting answers without sharing the answers with an expert.

Additionally, in at least one embodiment, based at least in part on the functional requirements, non-functional requirements are derived. One or more policy parameters (e.g., which can be specific to a given enterprise) can then be applied on top of the non-functional requirements to narrow down further options. For example, an enterprise policy to not allow more than 500 users onto a public cloud environment (due, for example, to cost considerations) will disallow the public cloud option for projects that have few users and which have projected users <500 over a given temporal period. Further, such threads can culminate in the possible options that are available for the given user. For example, in an illustrative insurance context, an unhealthy person may be only provided with a unit linked insurance plan (ULIP) option associated with a certain number of years. Similarly, an on-premises deployment will not be provided with any hybrid and/or public cloud connectivity.

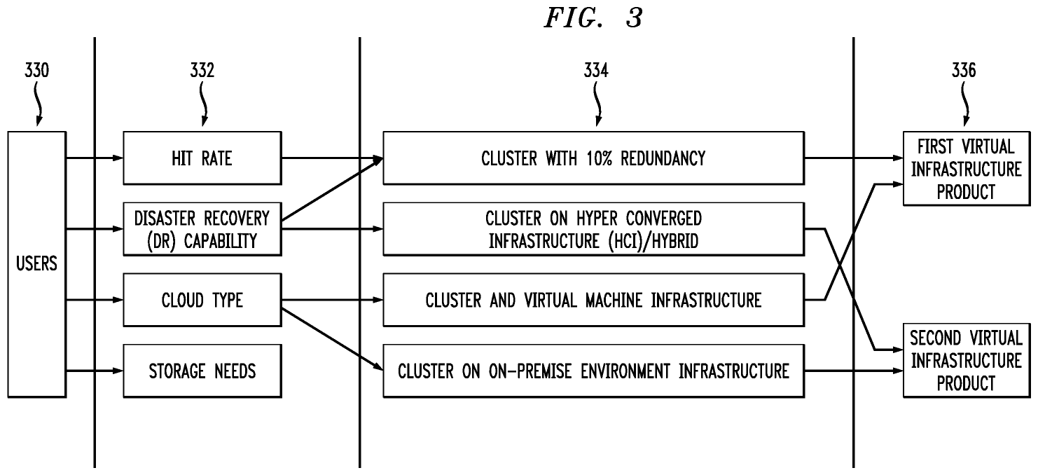

Such diagrams (as depicted, for example, in FIG. 2 and FIG. 3) can be fed back into an accessible common repository. Feeds from different vendors can help to create a more diverse and detailed logic that facilitates determination of improved and/or appropriate decision-making solutions for at least one given user.

FIG. 2 shows an example insurance-related decision tree in an illustrative embodiment. By way of illustration, FIG. 2 depicts a network diagram related to a domain expertise inquiry, specifically with respect to an example insurance-related decision tree. The network diagram includes a set of user parameters 220, which include age and premium paying capacity. The network diagram also includes a set of functional requirements 222, which include health-related aspects related to the “age” user parameter, such as smoker versus non-smoker, smoke-related ailments, other ailments and family history. The set of functional requirements 222 also include temporal aspects related to “premium paying capacity” user parameter, such as five years, ten years, and fifteen years. Also, the network diagram includes a set of options 224, which can be selected and/or identified based at least in part on one or more of the functional requirements 222. As depicted in FIG. 2, the options 224 include term insurance, ULIP, guaranteed return, and endowment return.

More specifically, as depicted in FIG. 2, the functional requirements 222 associated with this example embodiment are ordered in priority and in the form of a network diagram. For example, an insurance agent would likely want to know the current age of the person, whether the person is married or not (based, for example, on the person's age), whether the person is a smoker, whether the person has any ailments related thereto and/or related to age, and whether the person has any other relevant medical history and/or family medical history. The progressive sequence of such questions can provide a perspective on the level of potential risk associated with the person, which can help dictate the options 224 offered and/or suggested (in connection with, in this example embodiment, the person's capacity for paying premiums). Creating an exhaustive diagram such as depicted in FIG. 2 can facilitate one or more embodiments automatically and/or dynamically reflecting upon the answers without sharing all of them with a given human subject matter and/or domain expert.

FIG. 3 shows an example deployment-related decision tree in an illustrative embodiment. By way of illustration, FIG. 3 depicts a network diagram related to a domain expertise inquiry, specifically with respect to an example deployment-related decision tree. The network diagram includes user parameters 330, which include user identification and/or related information. The network diagram also includes a set of functional requirements 332, which include hit rate, disaster recovery (DR) capability, cloud type, and storage needs. Also, the network diagram includes a set of non-functional requirements 334, which include cluster with 10% redundancy, cluster on hyper converged infrastructure (HCI) and/or hybrid, cluster and a virtual machine infrastructure, and cluster on on-premises environment infrastructure. Further, as depicted in FIG. 3, the network diagram includes a set of options 336, which can be selected and/or identified based at least in part on one or more of the non-functional requirements 334 and/or one or more of the functional requirements 332. As illustrated in FIG. 3, the options 336 include a first virtual infrastructure product and a second virtual infrastructure product.

Similar to the example embodiment detailed in connection with FIG. 2, the functional requirements 332 associated with this FIG. 3 example embodiment are ordered in priority and in the form of a network diagram. The progressive sequence of such queries, in conjunction with a similar progressive sequence of queries associated with the non-functional requirements 334, can provide a perspective on the potential needs associated with the users, which can help dictate the options 336 offered and/or suggested.

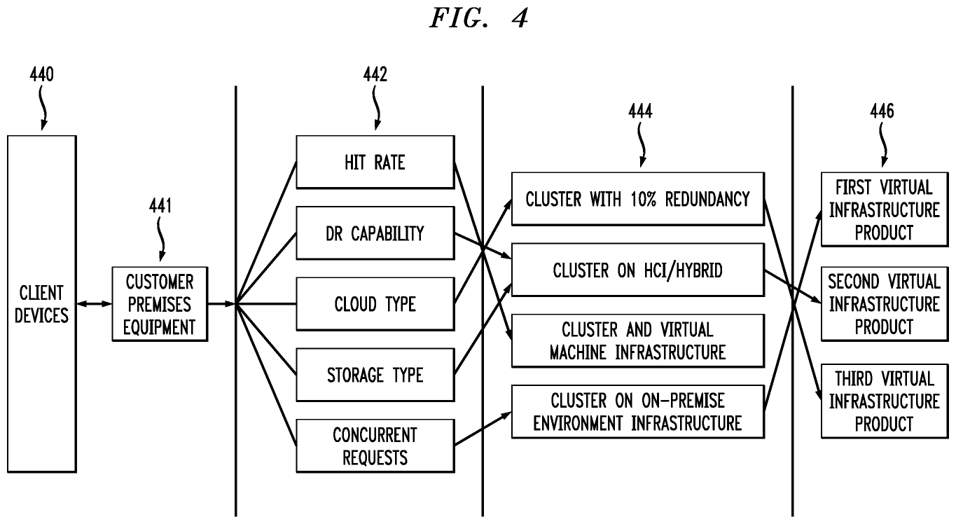

FIG. 4 shows an example deployment-related decision tree in an illustrative embodiment. By way of illustration, FIG. 4, similar to FIG. 3, depicts a network diagram related to a domain expertise inquiry, specifically with respect to an example deployment-related decision tree. The network diagram includes client devices 440 (e.g., mobile devices, laptops, servers, network providers, etc.) interacting and/or communicating with customer premises equipment (CPE) 441. CPE 441, which can be configured, for example, in connection with input from one or more subject matter experts, acts, in one or more embodiments, as an example of a data collection agent (as depicted, e.g., as element 112 in FIG. 1). For instance, CPE 441 can process data from client devices 440 and, based at least in part on such processing, learn and/or understand the user's/customer's needs and facilitate provisioning of at least one recommended solution option. CPE 441 can collect metrics from client devices 440, ensure confidentiality of any related data, and abstract one or more particular items information from such data to determine and/or identify at least one recommended solution option for the user/customer.

The network diagram of FIG. 4 also includes a set of functional requirements 442, which include hit rate, DR capability, cloud type, storage type, and concurrent requests. Also, the network diagram includes a set of non-functional requirements 444, which include cluster with 10% redundancy, cluster with HCI and/or hybrid, cluster and a virtual machine infrastructure, and cluster on on-premises environment infrastructure. Further, as depicted in FIG. 4, the network diagram includes a set of recommended options 446, which can be selected and/or identified based at least in part on one or more of the non-functional requirements 444 and/or one or more of the functional requirements 442. As illustrated in FIG. 4, the recommended options 446 include a first virtual infrastructure product, a second virtual infrastructure product, and a third virtual infrastructure product.

Similar to the example embodiment detailed in connection with FIG. 3, the functional requirements 442 associated with this FIG. 4 example embodiment are ordered in priority and in the form of a network diagram. Based at least in part on data collected and/or processed by CPE 441, the progressive sequence of such queries, in conjunction with a similar progressive sequence of queries associated with the non-functional requirements 444, can provide a perspective on the potential needs associated with the users (e.g., users associated with client devices 440), which can help dictate the options 446 offered and/or suggested.

Additionally, in one or more embodiments, CPE 441 can perform classification on one or more data collection parameters (as collected from client devices 440) and can use at least a portion of such classification(s) in connection with determining and/or processing one or more of the functional requirements 442 and/or one or more of the non-functional requirements 444 in furtherance of generating and/or determining at least one of the recommended options 446 for the user/customer.

It is noted that, with respect to the example embodiments depicted in FIG. 2, FIG. 3 and FIG. 4, specific deployment and/or insurance details are not provided, and the actual deployment risk and/or insurance premium assessment(s) can be in part provided by one or more subject matter experts based at least in part on the level of information generated by the example embodiments in question (e.g., with permission and/or consent from the corresponding user(s)).

As also detailed herein, one or more embodiments include user intent-based reprovisioning. Such an embodiment includes leveraging metadata defined in one or more systems (e.g., any client in a client system (e.g., an enterprise space and/or a consumer space)) and/or repositories (e.g., one or more subject matter expert-related systems) as well as data from one or more related applications (e.g., any application which is being utilized in a client system).

Leveraging and/or collecting such data and/or metadata can be carried out, for example, using one or more application programming interfaces (APIs) and/or a data collection agent.

In at least one embodiment, such user intent-based reprovisioning can be carried out using at least one user reprovisioning engine. A user reprovisioning engine can perform multiple tasks, such as detailed below. For example, the user reprovisioning engine monitors entities (friends, family, other deployments, etc.) similar to those related to one or more user decision-making contexts, and identifies and/or determines one or more patterns that trigger one or more types of actions (e.g., common actions such as medical conditions which trigger a need for health insurance).

Also, the user reprovisioning engine can feed and/or provide data extracted via a data collection agent into at least one particular expert inquiry repository diagram (such as the examples depicted in FIG. 2, FIG. 3 and FIG. 4), and determine one or more potential options that can be selected based at least in part on the current state of the user in question. Further, the user reprovisioning engine monitors changes in metadata uploaded to one or more repositories (e.g., a domain repository and/or a domain expertise inquiry repository) and triggers reevaluation of the option(s) for the user. The user reprovisioning engine can also rank one or more of the determined options based at least in part on the net benefits thereof and request user consent to proceed with at least one of the options. Based at least in part on the received user consent and the degree of detail to be shared, at least one embodiment can then include proceeding with the next course of action (e.g., automatically initiating at least one of the determined options).

By way merely of illustration, consider the following example use case, which can include a preprocessing step of building a domain repository based at least in part on information pertaining to functional requirements related to the given domain, non-functional requirements related to the given domain, policy parameters related to the given domain, and user intent detection data (which can include, for example, data pertaining to a given client system in a system deployment context).

Building such a repository can include, for example, analyzing application forms, proposal request forms, frequently asked questions and corresponding recommendations, etc., wherein such data can originate and/or be generated at least in part by one or more domain experts and/or one or more subject matter experts.

Additionally, such an example use case can include implementation of a data collection agent, which can include a system and/or device running at the user premises on one or more components of infrastructure (e.g., every component of relevant infrastructure) to gather information based, e.g., on one or more defined service level agreements (SLAs). In one or more embodiments, a data collection agent is implemented and enabled on user devices (e.g., client devices servers, etc.) which are on-premises in connection with at least one user location.

In the example use case, the data collection agent, in conjunction with one or more domain-related repositories, classifies gathered and/or obtained parameter data and/or information related to at least one given user decision-making context (e.g., storage data, throughput data, DR mechanism data, hit rate data, gateway-related information, etc.), into a set of functional requirements (for the at least one given user decision-making context). The data collection agent can also update the learning and reclassifying of data and/or information based at least in part on one or more infrastructure changes to one or more relevant systems and/or devices. In at least one example embodiment, infrastructure changes can be related to usage and associated risks. Such an embodiment can include preemptively informing, based at least in part on the noted infrastructure changes, a corresponding client system and/or application, e.g., to upgrade to a newer infrastructure stack and/or reduce to a lower infrastructure stack.

Also, in the example use case, the data collection agent performs classification of gathered and/or obtained synthetic information in terms of non-functional requirements based at least in part, for example, on digital footprints associated with the synthetic information (e.g., non-functional aspects of a given system such as, for example, user traffic, system performance, system integration(s), user preferences, etc.). Such non-functional requirements can represent supporting requirements incorporated for improved and/or enhanced output(s).

In at least one embodiment, the data collection agent can also process data and/or information from one or more sources to learn and/or understand user-related information pertaining to engagement, security, performance, usage and budgetary requirements as related to the decision-making context.

In such an embodiment, data collection involves collecting and analyzing data related to a given system's hardware and software configurations, network topology, storage infrastructure, and/or other relevant factors. Such information can then be used to create a baseline of the system's current state. Further, by way merely of example, in at least one embodiment, the system's current state information can be processed and/or compared against various cloud-based infrastructure options and/or historical data relating to similar system state information using at least one machine learning model to identify at least one option and/or recommendation (e.g., the most suitable option) for migration. Also, such analysis can include the use of one or more specialized tools and/or techniques for data collection, analysis, and visualization, such as one or more configuration management databases (CMDBs), one or more network scanning tools, and/or one or more asset management systems.

Additionally, in connection with such an embodiment, the at least one machine learning model used to generate and/or determine at least one cloud-based migration option and/or recommendation can be built using one or more decision trees, one or more random forests, one or more support vector machines (SVMs), at least one artificial neural network (ANN) and/or one or more similar algorithms. Also, one or more embodiments can include building the at least one machine learning model using one or more classification algorithms (e.g., one or more logistic regression algorithms, one or more naïve Bayes algorithms, one or more k-nearest neighbors algorithms, etc.) in a similar way.

Additionally, in the example use case, at least a portion of the data and/or information classified by the data collection agent is processed using one or more machine learning techniques, which determines and/or outputs, to the user, one or more options (e.g., the best circumstantial option(s)) for the user in connection with moving forward with the decision-making context. By way merely of example, in an information technology deployment use case, such an output can include one or more recommended options related to virtual infrastructure such as cloud storage suggestions, load balancer suggestions, etc. Additionally or alternatively, the one or more determined and/or recommended options can be output to at least one domain expert and/or subject matter expert, who can collaborate with the user to reach a solution to the given decision-making context.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations. For example, one or more of the models described herein may be trained to generate recommendations based at least in part on functional requirements related to a decision-making context, non-functional requirements related to the decision-making context, policy requirements related to a decision-making context, etc., and such recommendations can be used to initiate one or more automated actions (e.g., automatically initiating at least one of the recommendations, automatically outputting the recommendations to one or more domain experts, re-training and/or tuning one or more machine learning techniques using feedback related to the recommendations).

FIG. 5 is a flow diagram of a process for task-related data processing using machine learning techniques in an illustrative embodiment. It is to be understood that this particular process is only an example, and additional or alternative processes can be carried out in other embodiments.

In this embodiment, the process includes steps 500 through 506. These steps are assumed to be performed by automated task-related recommendation generation system 105 utilizing elements 112, 114 and 116.

Step 500 includes obtaining data related to at least one decision-making context in connection with at least one user. In at least one embodiment, the at least one decision-making context includes at least one information technology deployment-related decision-making context, and in such an embodiment, obtaining data related to at least one decision-making context in connection with at least one user can include obtaining one or more of storage data, throughput data, hit rate data, and gateway-related information. Additionally or alternatively, obtaining data related to at least one decision-making context in connection with at least one user can include obtaining the data in accordance with one or more defined service level agreements associated with the at least one user.

Step 502 includes classifying at least a portion of the obtained data into one or more of multiple categories of action-related requirements associated with the at least one decision-making context. In one or more embodiments, classifying at least a portion of the obtained data includes determining one or more user-related patterns pertaining to the at least one decision-making context by processing the at least a portion of the obtained data. Also, classifying at least a portion of the obtained data can include classifying the at least a portion of the obtained data into one or more of multiple categories of functional requirements associated with the at least one decision-making context and multiple categories of non-functional requirements associated with the at least one decision-making context. Additionally or alternatively, classifying at least a portion of the obtained data can include classifying the at least a portion of the obtained data into one or more of the multiple categories of action-related requirements associated with the at least one decision-making context in response to one or more infrastructure changes to one or more systems associated with the at least one decision-making context.

Step 504 includes recommending one or more tasks in furtherance of the at least one decision-making context by processing at least a portion of the classified data using one or more machine learning techniques. In at least one embodiment, the at least one decision-making context includes at least one information technology deployment-related decision-making context, and in such an embodiment, recommending one or more tasks in furtherance of the at least one decision-making context can include recommending one or more tasks related to virtual infrastructure.

Step 506 includes performing one or more automated actions based at least in part on the one or more recommended tasks. In one or more embodiments, performing one or more automated actions includes automatically initiating at least one of the one or more recommended tasks and/or automatically outputting information pertaining to the one or more recommended tasks to one or more domain experts associated with the at least one user and the at least one decision-making context. Additionally or alternatively, performing one or more automated actions can include training at least a portion of the one or more machine learning techniques based at least in part on feedback related to the one or more recommended tasks.

The techniques depicted in FIG. 5 can also include, for example, building at least one domain-related repository pertaining to the at least one decision-making context based at least in part on information pertaining to one or more domain-specific requirements related to the at least one decision-making context and one or more policy parameters related to the at least one decision-making context. In such an embodiment, building the at least one domain-related repository can include processing domain-related application forms, domain-related proposal request forms, and domain-related questions and/or corresponding responses.

Additionally, it is to be noted and acknowledged that, in one or more embodiments, the automated action(s) referred to in step 506 are distinct from actions associated with the action-related requirements referred to in step 502.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically process task-related data using machine learning techniques. These and other embodiments can effectively overcome problems associated with error-prone and resource-intensive outcomes.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

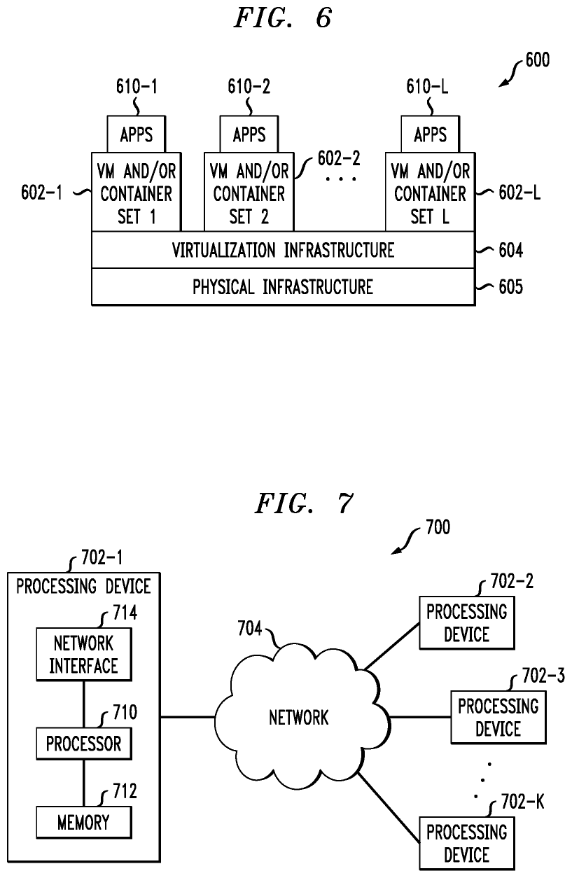

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data related to at least one decision-making context in connection with at least one user;
classifying at least a portion of the obtained data into one or more of multiple categories of action-related requirements associated with the at least one decision-making context;
recommending one or more tasks in furtherance of the at least one decision-making context by processing at least a portion of the classified data using one or more machine learning techniques; and
performing one or more automated actions based at least in part on the one or more recommended tasks;
wherein the method is performed by at least one processing device comprising a processor coupled to a memory.

2. The computer-implemented method of claim 1, wherein classifying at least a portion of the obtained data comprises classifying the at least a portion of the obtained data into one or more of multiple categories of functional requirements associated with the at least one decision-making context and multiple categories of non-functional requirements associated with the at least one decision-making context.

3. The computer-implemented method of claim 1, wherein performing one or more automated actions comprises automatically initiating at least one of the one or more recommended tasks.

4. The computer-implemented method of claim 1, wherein performing one or more automated actions comprises automatically outputting information pertaining to the one or more recommended tasks to one or more domain experts associated with the at least one user and the at least one decision-making context.

5. The computer-implemented method of claim 1, wherein performing one or more automated actions comprises training at least a portion of the one or more machine learning techniques based at least in part on feedback related to the one or more recommended tasks.

6. The computer-implemented method of claim 1, wherein classifying at least a portion of the obtained data comprises determining one or more user-related patterns pertaining to the at least one decision-making context by processing the at least a portion of the obtained data.

7. The computer-implemented method of claim 1, wherein classifying at least a portion of the obtained data comprises classifying the at least a portion of the obtained data into one or more of the multiple categories of action-related requirements associated with the at least one decision-making context in response to one or more infrastructure changes to one or more systems associated with the at least one decision-making context.

8. The computer-implemented method of claim 1, further comprising:
building at least one domain-related repository pertaining to the at least one decision-making context based at least in part on information pertaining to one or more domain-specific requirements related to the at least one decision-making context and one or more policy parameters related to the at least one decision-making context.

9. The computer-implemented method of claim 8, wherein building the at least one domain-related repository comprises processing one or more of domain-related application forms, domain-related proposal request forms, and domain-related questions and corresponding responses.

10. The computer-implemented method of claim 1, wherein the at least one decision-making context comprises at least one information technology deployment-related decision-making context, and wherein recommending one or more tasks in furtherance of the at least one decision-making context comprises recommending one or more tasks related to virtual infrastructure.

11. The computer-implemented method of claim 1, wherein the at least one decision-making context comprises at least one information technology deployment-related decision-making context, and wherein obtaining data related to at least one decision-making context in connection with at least one user comprises obtaining one or more of storage data, throughput data, hit rate data, and gateway-related information.

12. The computer-implemented method of claim 1, wherein obtaining data related to at least one decision-making context in connection with at least one user comprises obtaining the data in accordance with one or more defined service level agreements associated with the at least one user.

13. A non-transitory processor-readable storage medium having stored therein program code of one or more software programs, wherein the program code when executed by at least one processing device causes the at least one processing device:
to obtain data related to at least one decision-making context in connection with at least one user;
to classify at least a portion of the obtained data into one or more of multiple categories of action-related requirements associated with the at least one decision-making context;
to recommend one or more tasks in furtherance of the at least one decision-making context by processing at least a portion of the classified data using one or more machine learning techniques; and
to perform one or more automated actions based at least in part on the one or more recommended tasks.

14. The non-transitory processor-readable storage medium of claim 13, wherein classifying at least a portion of the obtained data comprises classifying the at least a portion of the obtained data into one or more of multiple categories of functional requirements associated with the at least one decision-making context and multiple categories of non-functional requirements associated with the at least one decision-making context.

15. The non-transitory processor-readable storage medium of claim 13, wherein performing one or more automated actions comprises automatically initiating at least one of the one or more recommended tasks.

16. The non-transitory processor-readable storage medium of claim 13, wherein performing one or more automated actions comprises automatically outputting information pertaining to the one or more recommended tasks to one or more domain experts associated with the at least one user and the at least one decision-making context.

17. An apparatus comprising:
at least one processing device comprising a processor coupled to a memory;
the at least one processing device being configured:
to obtain data related to at least one decision-making context in connection with at least one user;
to classify at least a portion of the obtained data into one or more of multiple categories of action-related requirements associated with the at least one decision-making context;
to recommend one or more tasks in furtherance of the at least one decision-making context by processing at least a portion of the classified data using one or more machine learning techniques; and
to perform one or more automated actions based at least in part on the one or more recommended tasks.

18. The apparatus of claim 17, wherein classifying at least a portion of the obtained data comprises classifying the at least a portion of the obtained data into one or more of multiple categories of functional requirements associated with the at least one decision-making context and multiple categories of non-functional requirements associated with the at least one decision-making context.

19. The apparatus of claim 17, wherein performing one or more automated actions comprises automatically initiating at least one of the one or more recommended tasks.

20. The apparatus of claim 17, wherein performing one or more automated actions comprises automatically outputting information pertaining to the one or more recommended tasks to one or more domain experts associated with the at least one user and the at least one decision-making context.
